(19) United States
(12) Patent Application Publication
(10) Pub. No.: US 2025/0243435 A1
(43) Pub. Date: Jul. 31, 2025

(54) A METHOD FOR MANUFACTURING A DETERGENT PORTION UNIT

(71) Applicant: HENKEL AG & CO. KGAA, Düsseldorf (DE)

(72) Inventors: Matthias SUNDER, Düsseldorf (DE); Friedhelm SIEPMANN, Essen (DE); Lena KOEGEL, Krefeld (DE); Anna-Carina KLUCKOW, Düsseldorf (DE)

(21) Appl. No.: 18/854,120

(22) PCT Filed: Jan. 18, 2023
(86) PCT No.: PCT/EP2023/051058

§ 371 Date: Oct. 4, 2024

(30) Foreign Application Priority Data
Apr. 13, 2022 (DE) 10 2022 203 707.3

(51) Int. Cl. C11D 11/00; C11D 17/00

(52) U.S. Cl. CPC C11D 11/0094; C11D 17/0078; C11D 2111/12; C11D 2111/14

(57) ABSTRACT

A method for manufacturing a detergent portion unit including a dimensionally stable solid gel is described. First and second flowable compositions are mixed using a mixing device to form a surfactant-containing and gelling agent-containing mixture. The surfactant-containing and gelling agent-containing mixture is passed through a shaping device until the surfactant-containing and gelling agent-containing mixture solidifies to form a dimensionally stable solid gel strand. The dimensionally stable solid gel strand is continuously discharged from the shaping device.

The present invention relates to a method for manufacturing a detergent portion unit, comprising a solid gel.

Continuously changing requirements are placed on the forms of manufacture and supply of washing and cleaning agents. The main focus has, for quite some time, been on the convenient dosing of washing and cleaning agents by the consumer and the simplification of the work steps necessary for carrying out a washing or cleaning method. One technical solution is provided by pre-portioned washing or cleaning agents, e.g., water-soluble containers having one or more receiving compartments for powdered or liquid washing or cleaning agents. A further technical solution is provided by detergent tablets which can have a single-phase or multi-phase design.

To manufacture the water-soluble containers, water-soluble polymers are generally deformed to form receiving chambers, which are subsequently filled with a washing or cleaning agent and finally closed. The receiving chambers can be produced, for example, from water-soluble polymer films by means of deep-drawing methods. In an alternative embodiment of the method, a water-soluble polymer is deformed by means of injection molding to form a receptacle.

The water-soluble packaging material used for packaging the filled detergent portion units is generally hygroscopic. In the context of the production, packaging, storage, and subsequent use by the consumer, the water absorption tendency and water absorption capacity of the packaging means can cause the portion units to adhere to surfaces of machines or packaging means and not be able to be conveyed optimally, or adjacent portion units, e.g., in a common outer packaging, to adhere to one another. To avoid this adhesion tendency of the water-soluble portion units, it is possible to modify the surface properties thereof by applying a powder agent. The powdering of the water-soluble detergent portion units in turn requires an additional method step.

The water-soluble packaging materials used are generally not washing active or cleaning active, i.e., do not contribute to the product performance. The reduction in the amount of packaging with respect to the total weight of the detergent portion units would thus not result in loss of performance and would be welcomed on the grounds of sustainability and economic efficiency.

Finally, the washing performance provided by the detergent portion unit is directly related to the dissolution properties of the portion unit. Particularly with regard to the increasing use of cold washing methods, it is preferred to keep the thickness of the water-soluble film material contained in the detergent portion unit as low as possible in order to accelerate the dissolution process. However, the reduction in the thickness of the surrounding film material simultaneously requires a reduced mechanical stability of the portion units. Overcoming this apparent dichotomy of mechanical stability and dissolution rate of detergent portion units packaged using water-soluble films is still a relevant aspect in the development of water-soluble detergent portion units.

Detergent tablets, in which, however, sufficient mechanical stability and a high dissolution rate are irreconcilably opposed in a similar manner as in the case of the sachets, offer an alternative to the previously described sachets.

Multi-phase detergent portion units, for example in the form of core tablets, which in addition to a tableted body comprise wax or gel phases, offer an alternative to completely compressed detergent tablets. Thus, European patent EP 1 032 642 B1 describes, for example, detergent tablets comprising a compressed phase and an uncompressed gel phase, and a method for the manufacturing thereof.

Against the background of the prior art described above, the object of the application was that of providing efficient methods for manufacturing fast-dissolving detergent portion units that have high product and storage stability, can be packaged in a simple manner using minimal amounts of additional packaging materials, and appeal to the consumer based upon an attractive olfactory, visual, and/or tactile experience. The detergent portion units should have a high product performance and be easy and safe to handle for the consumer.

The application relates firstly to a method for manufacturing a detergent portion unit, comprising
a) a dimensionally stable solid gel, the method comprising the steps of:
   i) providing a first flowable, surfactant-containing composition;
   ii) providing a second flowable, gelling agent-containing composition, which is different from the first flowable composition;
   iii) continuously feeding the first and second flowable compositions to a mixing device;
   iv) mixing the first and second flowable compositions by means of the mixing device to form a surfactant-containing and gelling agent-containing mixture;
   v) continuously passing the surfactant-containing and gelling agent-containing mixture through a shaping device such that the surfactant-containing and gelling agent-containing mixture solidifies in the shaping device, and a dimensionally stable solid gel strand is formed;
   vi) continuously discharging the dimensionally stable solid gel strand from the shaping device.

The term “detergent portion unit” describes a supply form in which a measured portion of a washing or cleaning agent is present. Detergent portion units consequently refer both to supply forms for textile laundry and to supply forms for cleaning hard surfaces such as ceramics, glass, metal, or tiles. The detergent portion unit preferably has a weight of 14 g to 42 g, preferably of 18 g to 38 g, in particular of 20 g to 34 g.

The detergent portion unit comprises a solid gel. The detergent portion unit can consist of the solid gel. In this case, the solid gel preferably has a weight of 14 g to 42 g, more preferably of 18 g to 38 g, in particular of 20 g to 34 g. If the detergent portion unit comprises further constituents in addition to the solid gel, the weight of the solid gel is preferably 10 g to 28 g, preferably 12 g to 23 g, and in particular 15 g to 20 g.

Bodies which exhibit elastic deformation behavior under the action of force are referred to as solid gels. Bodies are considered dimensionally stable if they have an inherent dimensional stability that enables them to assume a non-disintegrating, three-dimensional shape under the usual conditions of manufacture, storage, transport, and handling by the consumer, this three-dimensional shape also not changing under the conditions mentioned over an extended period of time, preferably 4 weeks, particularly preferably 8 weeks, and in particular 32 weeks, i.e., under the usual conditions of manufacture, storage, transport, and handling by the consumer, the body remains in the three-dimensional geometric shape created during manufacture, i.e., it does not dissolve.

The method is particularly suitable for the packaging of solid gels having a high surfactant content. In preferred embodiments, the first flowable, surfactant-containing composition contains, based upon the total weight thereof, 30 to 70 wt. %, preferably 40 to 60 wt. %, and in particular 45 to 55 wt. % surfactant.

In terms of the manufacturability and the subsequent dissolving power of the solid gels, it has proven advantageous for them to contain 15 to 35 wt. %, preferably 20 to 30 wt. %, of an aqueous-organic solvent. The aqueous-organic solvent of the solid gel is preferably introduced via the first and the second flowable compositions. Thus, it is preferred if the second flowable, gelling agent-containing composition also contains an organic solvent. Particularly preferred flowable, gelling agent-containing compositions contain gelling agent and organic solvent in a total weight proportion above 50 wt. %, preferably above 70 wt. %, and in particular above 90 wt. %.

Preferred solid gels further contain dye.

Preferred solid gels are transparent. Such solid gels are referred to as “transparent” if they have a transmission above 50%, preferably above 60%, and in particular above 80%, in the wavelength range of 410 to 800 nm at at least one wavelength, preferably at 600 nm. The transmission is determined by means of VIS spectrometry at a sample temperature of 20° C. and a cuvette length of 10 mm.

For the manufacture and later storage and transport properties of the solid gels, it has proven advantageous to use low-molecular-weight gelling agents having a molar mass of up to 2,000 g/mol in the solid gel, wherein the weight proportion thereof with respect to the total weight of the solid gel is preferably less than 5 wt. %, preferably 0.1 to 5 wt. %, and particularly preferably 0.1 to 2.5 wt. %. Furthermore, the advantages of the method according to the invention are particularly evident in the processing of these low-molecular-weight gelling agents with their specific gelling properties.

In a preferred embodiment, the low-molecular-weight gelling agent has a solubility in water of less than 0.1 g/L (20° C.). The solubility of the organic gelator compound is determined at 20° C. in bidistilled, demineralized water.

Furthermore, gelling agents are preferably suitable which comprise a structure containing at least one hydrocarbon structural unit having 6 to 20 carbon atoms (preferably at least one carbocyclic, aromatic structural unit) and additionally an organic structural unit that is covalently bonded to the aforementioned hydrocarbon unit and has at least two groups selected from —OH, —NH—, or mixtures thereof.

Particularly preferred solid gels are characterized in that said solid gels contain at least one benzylidene alditol compound of formula (GB-I) as gelling agent

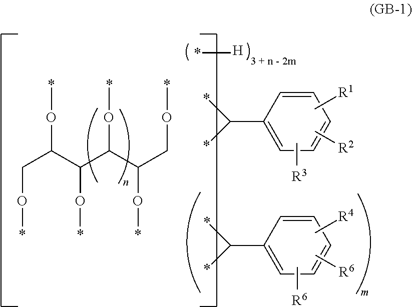

where

* represents a covalent single bond between an oxygen atom of the alditol backbone and the provided functional group,
n represents 0 or 1, preferably 1,
m represents 0 or 1, preferably 1,
R¹, R², and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵, and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring.

Due to the stereochemistry of the alditols, it should be mentioned that said benzylidene alditols according to the invention are suitable in the L configuration or in the D configuration or in a mixture of the two. Due to natural availability, the benzylidene alditol compounds are preferably used according to the invention in the D configuration. It has proven preferable if the alditol backbone of the benzylidene alditol compound according to formula (GB-I) contained in the shaped body is derived from D-glucitol, D-mannitol, D-arabinitol, D-ribitol, D-xylitol, L-glucitol, L-mannitol, L-arabinitol, L-ribitol, or L-xylitol.

Particularly preferred are those solid gels which are characterized in that R¹, R², R³, R⁴, R⁵, and R⁶ according to the benzylidene alditol compound of formula (GB-I) mean, independently of one another, a hydrogen atom, methyl, ethyl, chlorine, fluorine, or methoxy, preferably a hydrogen atom.
n according to the benzylidene alditol compound of formula (GB-I) preferably represents 1.
m according to the benzylidene alditol compound of formula (GB-I) preferably represents 1.

The solid gel very particularly preferably contains at least one compound of formula (GB-11) as the benzylidene alditol compound of formula (GB-I)

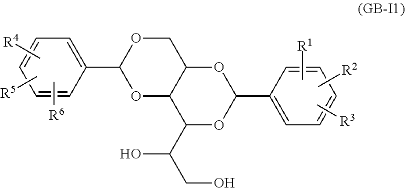

where R¹, R², R³, R⁴, R⁵, and R⁶ are as defined in formula (I). Most preferably, according to formula (GB-11), R¹, R², R³, R⁴, R⁵, and R⁶ represent, independently of one another, a hydrogen atom, methyl, ethyl, chlorine, fluorine, or methoxy, preferably a hydrogen atom.

Most preferably, the benzylidene alditol compound of formula (GB-I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol, or mixtures thereof.

Preferred solid gels contain at least one 2,5-diketopiperazine compound of formula (GB-II) as the gelling agent

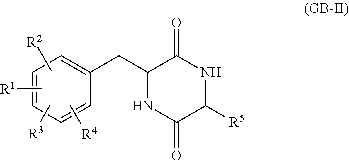

where
R¹, R², R³, and R⁴ represent, independently of one another, a hydrogen atom, a hydroxyl group, a (C₁-C₆)alkyl group, a (C₂-C₆)alkenyl group, a (C₂-C₆) acyl group, a (C₂-C₆) acyloxy group, a (C₁-C₆)alkoxy group, an amino group, a (C₂-C₆) acylamino group, a (C₁-C₆)alkylaminocarbonyl group, an aryl group, an aroyl group, an aroyloxy group, an aryloxy group, an aryl-(C₁-C₄)alkyloxy group, an aryl-(C₁-C₃)alkyl group, a heteroaryl group, a heteroaryl-(C₁-C₃)alkyl group, a (C₁-C₄) hydroxyalkyl group, a (C₁-C₄)aminoalkyl group, a carboxy-(C₁-C₃)alkyl group, where at least two of the functional groups R¹ to R⁴ can form, together with the remainder of the molecule, a 5-membered or 6-membered ring, R⁵ represents a hydrogen atom, a linear (C₁ to C₆)alkyl group, a branched (C₃ to C₁₀)alkyl group, a (C₃ to C₆) cycloalkyl group, a (C₂-C₆)alkenyl group, a (C₂-C₆)alkynyl group, a (C₁-C₄) hydroxyalkyl group, a (C₁-C₄)alkoxy-(C₁-C₄)alkyl group, a (C₁-C₄) acyloxy-(C₁-C₄)alkyl group, an aryloxy-(C₁-C₄)alkyl group, an O-(aryl-(C₁-C₄)alkyl)oxy-(C₁-C₄)alkyl group, a (C₁-C₄)alkylsulfanyl-(C₁-C₄)alkyl group, an aryl group, an aryl-(C₁-C₃)alkyl group, a heteroaryl group, a heteroaryl-(C₁-C₃)alkyl group, a (C₁-C₄) hydroxyalkyl group, a (C₁-C₄)aminoalkyl group, an N-(C₁-C₄)alkylamino-(C₁-C₄)alkyl group, an N,N-(C₁-C₄)dialkylamino-(C₁-C₄)alkyl group, an N-(C₂-C₈) acylamino-(C₁-C₄)alkyl group, an N-(C₂-C₈) acyl-N-(C₁-C₄)alkylamino-(C₁-C₄)alkyl group, an N-(C₂-C₈) aroyl-N-(C₁-C₄)alkylamino-(C₁-C₄)alkyl group, an N,N-(C₂-C₈)diacylamino-(C₁-C₄)alkyl group, an N-(aryl-(C₁-C₄)alkyl) amino-(C₁-C₄)alkyl group, an N,N-di(aryl-(C₁-C₄)alkyl) amino-(C₁-C₄)alkyl group, a (C₁-C₄) carboxyalkyl group, a (C₁-C₄)alkoxycarbonyl-(C₁-C₃)alkyl group, a (C₁-C₄) acyloxy-(C₁-C₃)alkyl group, a guanidino-(C₁-C₃)alkyl group, an aminocarbonyl(C₁-C₄)alkyl group, an N-(C₁-C₄)alkylaminocarbonyl-(C₁-C₄)alkyl group, an N,N-di((C₁-C₄)alkyl) aminocarbonyl-(C₁-C₄)alkyl group, an N-(C₂-C₅) acylaminocarbonyl-(C₁-C₄)alkyl group, an N,N-(C₂-C₈)diacylaminocarbonyl-(C₁-C₄)alkyl group, an N-(C₂-C₈) acyl-N-(C₁-C₄)alkylaminocarbonyl-(C₁-C₄)alkyl group, an N-(aryl-(C₁-C₄)alkyl) aminocarbonyl-(C₁-C₄)alkyl group, an N-(aryl-(C₁-C₄)alkyl)-N-(C₁-C₆)alkylaminocarbonyl-(C₁-C₄)alkyl group, or an N,N-di(aryl-(C₁-C₄)alkyl) aminocarbonyl-(C₁-C₄)alkyl group.

It is preferred according to the invention if R³ and R⁴ according to formula (GB-II) represent a hydrogen atom. It is particularly preferred according to the invention if R², R³, and R⁴ according to formula (GB-II) represent a hydrogen atom. Therefore, particularly preferred shaped bodies according to the invention contain at least one 2,5-diketopiperazine compound according to formula (GB-IIa)

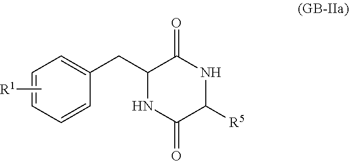

where R¹ and R⁵ are as defined under formula (GB-II) (vide supra).

It has been found preferable if the functional group R¹ according to formula (GB-II) and according to formula (GB-IIa) binds in the para position of the phenyl ring. In the sense of the present invention, shaped bodies according to the invention are therefore preferred which contain at least one 2,5-diketopiperazine compound according to formula (GB-IIb),

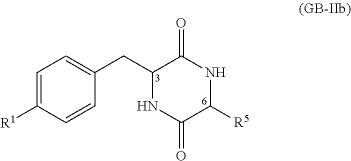

where R¹ and R⁵ are as defined under formula (GB-II) (vide supra). By way of illustration, numbers 3 and 6 positioned at the ring atoms in formula (GB-IIb) mark only positions 3 and 6 of the diketopiperazine ring, as they are generally used in the context of the invention for naming all 2,5-diketopiperazines according to the invention.

The 2,5-diketopiperazine compounds of formula (GB-II) have centers of chirality at least on the carbon atoms in positions 3 and 6 of the 2,5-diketopiperazine ring. The numbering of ring positions 3 and 6 has been illustrated by way of example in formula (GB-IIb). The 2,5-diketopiperazine compound of formula (GB-II) of the composition according to the invention is preferably, based upon the stereochemistry of the carbon atoms at the 3 and 6 position of the 2,5-diketopiperazine ring, the configuration isomer 3S,6S, 3R,6S, 3S,6R, 3R,6R, or mixtures thereof, particularly preferably 3S,6S.

Preferred solid gels contain at least one 2,5-diketopiperazine compound of formula (GB-II) as the gelling agent, selected from 3-benzyl-6-carboxyethyl-2,5-diketopiperazine, 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di(benzyl)-2,5-diketopiperazine, 3,6-di(p-hydroxybenzyl)-2,5-diketopiperazine, 3,6-di(p-(benzyloxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine, or mixtures thereof. In turn, compounds having the aforementioned configuration isomers are preferably suitable for selection.

It is also possible for the solid gels according to the invention to contain at least one diarylamidocystine compound of formula (GB-III) as the gelling agent a)

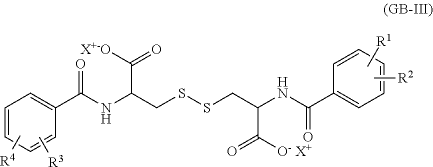

where
X⁺ independently represents a hydrogen atom or an equivalent of a cation,
R¹, R², R³, and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, an amino group, an N-(C₁-C₄-alkyl)amino group, an N,N-Di(C₁-C₄-alkyl)amino group, an N-(C₂-C₄-hydroxyalkyl)amino group, an N, N-Di(C₂-C₄-hydroxyalkyl)amino group, or R¹ with R² or R³ with R⁴ forms a 5-membered or 6-membered annulated ring, which in turn can in each case be substituted with at least one group from C₁-C₄ alkyl group, C₁-C₄ alkoxy group, C₂-C₄ hydroxyalkyl group, hydroxyl group, amino group, N-(C₁-C₄-alkyl)amino group, N,N-Di(C₁-C₄-alkyl)amino group, N-(C₂-C₄-hydroxyalkyl)amino group, N,N-Di(C₂-C₄-hydroxyalkyl)amino group.

Each of the stereocenters contained in the compound of formula (GB-III) can represent, independently of one another, the L or D stereoisomer. It is preferable according to the invention for the above-mentioned cystine compound of formula (GB-III) to be derived from the L stereoisomer of cysteine.

The above-mentioned solid gels can contain at least one compound of formula (GB-III), in which R¹, R², R³, and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, or hydroxyl group. In particular, shaped bodies which contain N,N′-dibenzoylcystine (R¹=R²=R³=R⁴=hydrogen atom; X⁺ independently=a hydrogen atom or an equivalent of a cation), in particular N,N′-dibenzoyl-L-cystine, as a diarylamidocystine compound of formula (GB-III) are particularly suitable.

The N-(C₈-C₂₄) hydrocarbylglyconamide compounds suitable as the gelling agent a) preferably have the formula (GB-IV)

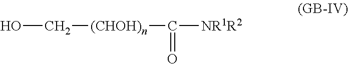

where
n is 2 to 4, preferably 3 or 4, in particular 4;
R¹ is selected from hydrogen, C₁-C₁₆ alkyl functional groups, C₁-C₃ hydroxy or methoxyalkyl functional groups, preferably C₁-C₈alkyl, hydroxyalkyl or methoxyalkyl functional groups, particularly preferably methyl;
R² is selected from C₈-C₂₄ alkyl functional groups, C₈-C₂₄ monoalkenyl functional groups, C₈-C₂₄ dialkenyl functional groups, C₈-C₂₄ trialkenyl functional groups, C₈-C₂₄ hydroxyalkyl functional groups, C₈-C₂₄ hydroxyalkenyl functional groups, C₁-C₃ hydroxyalkyl functional groups, or methoxy-C₁-C₃ alkyl functional groups, preferably C₈-C₁₈ alkyl functional groups and mixtures thereof, more preferably C₈, C₁₀, C₁₂, C₁₄, C₁₆, and C₁₈ alkyl functional groups and mixtures thereof, most preferably C₁₂ and C₁₄ alkyl functional groups or a mixture thereof.

In particularly preferred embodiments, the functional group

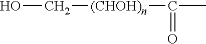

is one of a functional group derived from a glycuronic acid, in particular the glycuronic acid of a hexose (n=4). In particular, glucuronic acid should be mentioned as a preferred functional group. R¹ is preferably H or a short-chain alkyl functional group, in particular methyl. R² is preferably a long-chain alkyl functional group—for example, a C₈-C₁₈ alkyl functional group.

Compounds of formula (GB-IV1) are therefore very particularly preferred

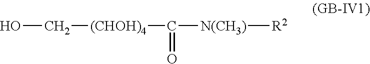

where R² has the meanings given for formula (GB-IV).

In a particularly preferred embodiment, the at least one low-molecular-weight gelling agent of the second flowable, gelling agent-containing composition is selected from the group consisting of the group of cyclic dipeptides, cyclic dipeptide derivatives, and dibenzylidene sorbitols. The at least one gelling agent of the second flowable, gelling agent-containing composition is more particularly preferably dibenzylidene sorbitol (DBS) because of its technical effect.

In step iii) of the method, the first and the second flowable compositions are fed to the mixing device. In one embodiment of the method, the first flowable composition and the second flowable composition are fed to the mold in the same line. This embodiment of the method is characterized by a reduced apparatus structure. In this embodiment of the method, the first and the second flowable compositions can be partially mixed as early as in the supply line leading to the mold. The disadvantages of this embodiment of the method are reduced control of the gelation process and, in the event of an interruption to production, increased cleaning effort before restarting the manufacturing equipment.

For the aforementioned reasons, it is preferable to feed the first flowable composition and the second flowable composition to the mixing device in separate lines.

The method embodiment according to the invention is particularly suitable for processes in the course of which flowable compositions are mixed in widely differing weight proportions. Thus, in the method according to the invention, the first flowable composition and the second flowable composition are mixed preferably in a weight ratio of 50:1 to 5:1, preferably 35:1 to 8:1.

For mixing, but also for further transfer to the shaping device, it has proven advantageous if the flowable compositions in the mixing device are subjected to a shear rate of 50 to 5,000 s−1, preferably of 80 to 2,000 s−1, and in particular of 100 to 1,200 s−1.

The mixing device is preferably selected from the group of rotor-stator mixers. Static-dynamic mixers are particularly preferably used.

Upon exiting the mixing device, the surfactant-containing and gelling agent-containing mixture preferably has a temperature above 23° C., particularly preferably a temperature in the range of 23° C. to 60° C.

The surfactant-containing and gelling agent-containing mixture is preferably introduced into the shaping device at a filling rate of 20 mL/s to 800 mL/s.

The devices known to the person skilled in the art for forming shaped strands are suitable as a shaping device. An embodiment of the method is particularly preferred in the course of which the mixture is continuously pressed out of a shaping opening under pressure.

The mixing device and the shaping device can be structurally integrated or designed as a separate device.

In its simplest embodiment, a sufficiently stable outlet opening is used as the shaping device. The opening area of this outlet opening determines the cross-sectional area of the exiting extruded strand.

In a further-developed embodiment, the shaping device is designed as a tube, one end of which serves as an inlet opening for the surfactant-containing and gelling agent-containing mixture and the other end of which serves as an outlet opening for the extruded strand. Again, the opening area of the outlet opening determines the cross-sectional area of the exiting extruded strand. The opening area of the tube and its cross-sectional area are preferably identical.

In a further development, the shaping device comprises a pipe and an outlet nozzle replaceably connected to said pipe.

If the shaping device and the mixing device are designed as separate devices, the surfactant-containing and gelling agent-containing mixture is preferably guided through a supply line after exiting the mixing device and before entering the shaping device.

If the surfactant-containing and gelling agent-containing mixture, after exiting the mixing device and before entering the shaping device, is guided through a supply line, the cross-sectional area of the supply line can differ from the cross-sectional area of the outlet opening in the shaping device. If the cross-sectional area of the supply line is smaller than the cross-sectional area of the outlet opening in the shaping device, the flow rate of the surfactant-containing and gelling agent-containing mixture is lower when exiting the supply line into the shaping device than when exiting the shaping device. The opposite is true in the cases in which the cross-sectional area of the supply line is greater than the cross-sectional area of the shaping device. Realizing different flow rates in the supply line and shaping device allows the curing behavior of the surfactant-containing and gelling agent-containing mixture to be suitably influenced.

The time period between the exit of the surfactant-containing and gelling agent-containing mixture and the entry of said mixture into the shaping device is preferably 1 to 20 seconds, particularly preferably 5 to 40 seconds. This applies in particular to embodiments of the method in which the mixing device and shaping device are designed separately.

If the mixing device and the shaping device are structurally integrated, e.g., in the form of a mixer with an attached outlet opening, a device for calibrating the extruded strand is preferably connected to the outlet opening. This calibration device can, for example, be designed in the form of a channel that is open at the top.

In order to accelerate solidification or to facilitate further packaging, the dimensionally stable solid gel strand is preferably cooled. The cooling preferably takes place under defined climatic conditions in which, in addition to the temperature, the humidity in the process chamber is also controlled and regulated, for example.

The extruded strand exiting the shaping device is preferably cut to length subsequent to step vi) in a suitable manner for forming individual shaped bodies. The strand is particularly preferably cut to length by means of ultrasonic cutting.

The three-dimensional shape of the solid gel is basically freely selectable; its side surfaces can, for example, be designed to be convex, concave, or planar. At the same time, however, certain spatial configurations have proven to be particularly advantageous against the background of the manufacturability, storage, and use of the solid gels.

In correspondingly advantageous detergent portion units, the solid gel comprises a flat underside, the largest diagonal of which is greater than the height of the solid gel. Not only can these bodies be manufactured in a simple manner, e.g., by means of casting methods, but they can also be packaged in a simple and space-saving manner and are suitable for dosing via the dosing or dispensing chambers of electronic cleaning devices. It is particularly preferred if the solid gel has a flat underside, the largest diagonal of which is more than 1.5 times, preferably more than twice, the height of the solid gel.

For manufacturability, e.g., in relation to the removal of the solid gel from a casting mold, it has proven to be advantageous if the underside of the solid gel does not have any corners. Preferred solid gels are therefore characterized by oval undersides or alternatively by ellipsoidal or round, preferably round, undersides. Corresponding solid gels with non-angular undersides are also preferred by many consumers due to their optics. For example, such solid gels having an underside and an upper side which are connected to one another by a cylindrical lateral surface are therefore preferred.

Advantages with respect to the use of space during manufacture and packaging are realized by angular undersides. If the solid gels are molded, for example, in the form of plates, which are subsequently cut into solid gels, angular undersides are advantageous, since such solid gels can be cut without any residual amounts occurring and can be packaged in a space-saving manner. In an alternative embodiment, preferred solid gels therefore have angular undersides, in particular triangular, square, or hexagonal undersides. For further processing or packaging, it can be advantageous if the solid gel has an angular underside with rounded corners.

With regard to the manufacture, packaging, and use of the detergent portion units, it has also proven to be advantageous if the solid gels have an upper side plane-parallel to the underside.

In a first preferred geometric embodiment, the solid gel has an underside and an upper side which have the same geometric shape, wherein the underside and the upper side have the same surface size. As already described above, corresponding solid gels can be produced in a simple manner—for example, by casting plates and subsequently cutting the plates into individual solid gels. In addition, in any subsequent method steps, said solid gels can be spatially aligned during packaging or use by the user due to the geometric identity of the underside and upper side as solid gels with reduced body symmetry. This applies in particular to solid gels which at the same time have a upper side plane parallel to the underside. Examples of such solid gels are circular cylinders, elliptical cylinders, parallelepipeds, rhomboids, straight or oblique prisms, cuboids, or cubes. The group of circular cylinders and elliptical cylinders in turn includes vertical circular cylinders and elliptical cylinders as well as the inclined circular cylinders and elliptical cylinders. Due to their simple production by isolation from a plate, solid gels in the form of vertical circular cylinders, vertical elliptical cylinders, straight prisms, straight cuboids, or cubes are preferred.

In an alternative embodiment, the solid gel has an underside and an upper side which have the same geometric shape, wherein the underside and the upper side have different surface sizes. Corresponding solid gels can be preferred due to their attractive appearance or their optimized fit, while simultaneously being comparatively simple to manufacture. Examples of such solid gels include circular cylinders or elliptical cylinders with a convex or concave underside and a planar upper side. Further examples include truncated cones or truncated pyramids.

In summary, preferred subject matter of the application can be characterized as detergent portion units comprising a solid gel having an underside and an upper side, wherein the surface area of the upper side is 80 to 100%, preferably 90 to 100%, and in particular 98 to 100% of the underside.

In order to manufacture detergent portion units which comprise further components in addition to the solid gel, a procedure is suitable in which the solid gel is bonded to a prefabricated shaped body.

In a preferred method variant, the solid gel strand is covered with a shaped body. Alternatively or in combination with covering by means of a shaped body, the dimensionally stable solid gel strand is discharged onto a prefabricated shaped body. If the solid gel strand is discharged onto a first prefabricated shaped body and the side opposite the side covered with the first prefabricated shaped body is covered with a second prefabricated shaped body, a sandwich-like detergent portion unit, which is particularly advantageous in terms of handling and optics, is obtained.

A particularly preferred method variant for manufacturing a detergent portion unit comprising
a) a dimensionally stable solid gel
b) two shaped bodies comprises the steps of:
   i) providing a first flowable, surfactant-containing composition;
   ii) providing a second flowable, gelling agent-containing composition, which is different from the first flowable composition;
   iii) continuously feeding the first and second flowable compositions to a mixing device;
   iv) mixing the first and second flowable compositions by means of the mixing device to form a surfactant-containing and gelling agent-containing mixture;
   v) continuously passing the surfactant-containing and gelling agent-containing mixture through a shaping device such that the surfactant-containing and gelling agent-containing mixture solidifies in the shaping device, and a dimensionally stable solid gel strand is formed;
   vi) continuously discharging the dimensionally stable solid gel strand from the shaping device onto at least one first prefabricated shaped body;
   vii) covering the side of the solid gel strand opposite to the side covered by the first prefabricated shaped body with a second prefabricated shaped body;
   viii) cutting the solid gel strand to length to form a detergent portion unit comprising a solid gel and the first and the second prefabricated molded bodies.

The shaped body can be packaged in different ways. The use of casting bodies has proven to be technically easy to implement. The manufacture of the shaped body using casting processes has the advantage that a wide variety of geometries can be produced. The casting bodies are particularly preferably solidified melts.

Due to their ease of manufacture on an industrial scale, extruded bodies, in particular tablets, are particularly preferred as shaped bodies.

Irrespective of the method used for its manufacture, the shaped body preferably has a breaking strength of 50 N to 300 N, in particular of 50 N to 150 N. This breaking strength ensures, on the one hand, that the shaped body is sufficiently stable during production, transport, and handling by the consumer and, on the other hand, ensures a satisfactory dissolution behavior of the shaped body in an aqueous liquor. The hardness of the shaped body is measured by deformation of the shaped body until fracture, wherein the force acting upon the side surfaces of the shaped body and the maximum force that it withstands are determined. In order to determine the level of shaped body hardness, a tablet testing apparatus from the company Sotax is suitable, for example.

Preferred shaped bodies have an imprint.

If the solid gel is combined with a shaped body as described above, the dimensionally stable solid gel, which is partially covered by a shaped body, is finally removed from the mold. The solid gel and the shaped body are preferably adhesively bonded to one another.

In a preferred embodiment of the detergent portion units, the shaped body also contributes to the active washing and active cleaning effect. Corresponding detergent portion units comprise a shaped body which, based upon its total weight, contains more than 40 wt. %, preferably more than 60 wt. %, particularly preferably more than 80 wt. %, of active washing or active cleaning ingredient.

Fragrances form a first group of active washing or active cleaning ingredients integrated into the shaped body. Their incorporation into the shaped body ensures a fragrance experience that can be perceived by the consumer and which cannot be ensured in the same way when the fragrances are incorporated into the solid gel.

Builders constitute a further group of active washing or active cleaning ingredients preferably incorporated into the casing substance, in particular the citrates, zeolites, silicates, and carbonates, particularly preferably in particular the citrates and zeolites. The proportion by weight of said active ingredients with respect to the total weight of the casing substance is preferably 5 to 60 wt. %, in particular 10 to 50 wt. %. Casing substances which contain, based upon the total weight thereof, 5 to 60 wt. %, in particular 10 to 50 wt. % of zeolite are particularly preferred. These active substances not only contribute to the washing and cleaning effect as intended, but also improve the contour sharpness and resistance of the imprinted image in the event of the shaped body surface being imprinted.

The use of an active substance from the group of polymeric active washing or active cleaning ingredient, preferably from the group of celluloses and cellulose derivatives, and of the anionic or non-ionic aromatic polyesters, preferably from the group of celluloses, microcrystalline celluloses and carboxymethyl celluloses, and of the anionic or non-ionic aromatic polyesters, is also advantageous for the contour sharpness and resistance of the imprinted image. The proportion by weight of said cellulose-based active ingredients with respect to the total weight of the casing substance is preferably 2 to 50 wt. %.

The composition of some preferred detergent portion units can be found in the following tables (amounts given in wt. % based upon the total weight of the solid gel or the casing substance, unless otherwise indicated).

| | | | |
|---|---|---|---|
| Formula 1 | Formula 2 | Formula 3 | Formula 4 |

Solid gel

| | | | | |
|---|---|---|---|---|
| Total surfactant | 30 to 70 | 40 to 60 | 40 to 60 | 45 to 55 |
| Anionic | 20 to 40 | 20 to 40 | 25 to 35 | 25 to 35 |
| surfactant | | | | |
| Alkyl ethoxylate | 15 to 30 | 15 to 30 | 20 to 30 | 20 to 30 |
| Enzyme | 0.2 to 8 | 0.3 to 6 | 0.3 to 6 | 0.3 to 6 |
| preparation | | | | |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Shaped body

| | | | | |
|---|---|---|---|---|
| Builder from the | 5 to 90 | 50 to 90 | 50 to 80 | 50 to 80 |
| group of citrates, | | | | |
| zeolites, | | | | |
| silicates, and | | | | |
| carbonates | | | | |

| | | | |
|---|---|---|---|
| Formula 6 | Formula 7 | Formula 8 | Formula 9 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme | 0.2 to 8 | 0.3 to 6 | 0.3 to 6 | 0.3 to 6 |
| preparation | | | | |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from the | 5 to 90 | 50 to 90 | 50 to 80 | 50 to 80 |
| group of citrates, | | | | |
| zeolites, silicates, | | | | |
| and carbonates | | | | |
| Cellulose and | 0.5 to 10 | 1.0 to 8.0 | 1.0 to 5.0 | 1.0 to 5.0 |
| cellulose | | | | |
| derivatives | | | | |

| | | | |
|---|---|---|---|
| Formula 11 | Formula 12 | Formula 13 | Formula 14 |

Solid gel

| | | | | |
|---|---|---|---|---|
| Total surfactant | 30 to 70 | 40 to 60 | 40 to 60 | 45 to 55 |
| Anionic | 20 to 40 | 20 to 40 | 25 to 35 | 25 to 35 |
| surfactant | | | | |
| Alkyl | 15 to 30 | 15 to 30 | 20 to 30 | 20 to 30 |
| ethoxylate | | | | |
| Enzyme | 0.2 to 8 | 0.3 to 6 | 0.3 to 6 | 0.3 to 6 |
| preparation | | | | |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from | 10 to 70 | 20 to 60 | 20 to 60 | 30 to 50 |
| the group | | | | |
| of citrates | | | | |
| and zeolites | | | | |

| | | | |
|---|---|---|---|
| Formula 15 | Formula 16 | Formula 17 | Formula 18 |

Solid gel

| | | | | |
|---|---|---|---|---|
| Total surfactant | 30 to 70 | 40 to 60 | 40 to 60 | 45 to 55 |
| Anionic | 20 to 40 | 20 to 40 | 25 to 35 | 25 to 35 |
| surfactant | | | | |
| Alkyl | 15 to 30 | 15 to 30 | 20 to 30 | 20 to 30 |
| ethoxylate | | | | |
| Enzyme | 0.2 to 8 | 0.3 to 6 | 0.3 to 6 | 0.3 to 6 |
| preparation | | | | |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from | 10 to 70 | 20 to 60 | 20 to 60 | 30 to 50 |
| the group | | | | |
| of citrates | | | | |
| and zeolites | | | | |
| Cellulose and | 0.5 to 10 | 1.0 to 8.0 | 1.0 to 5.0 | 1.0 to 5.0 |
| cellulose | | | | |
| derivatives | | | | |

In summary, the following subject matter, inter alia, is provided by this application:
1. A method for manufacturing a detergent portion unit, comprising
a) a dimensionally stable solid gel, the method comprising the steps of:
   i) providing a first flowable, surfactant-containing composition;
   ii) providing a second flowable, gelling agent-containing composition, which is different from the first flowable composition;
   iii) continuously feeding the first and second flowable compositions to a mixing device;
   iv) mixing the first and second flowable compositions by means of the mixing device to form a surfactant-containing and gelling agent-containing mixture;
   v) continuously passing the surfactant-containing and gelling agent-containing mixture through a shaping device such that the surfactant-containing and gelling agent-containing mixture solidifies in the shaping device, and a dimensionally stable solid gel strand is formed;
   vi) continuously discharging the dimensionally stable solid gel strand from the shaping device.
2. The method according to point 1, wherein the first flowable, surfactant-containing composition contains, based upon the total weight thereof, 30 to 70 wt. %, preferably 40 to 60 wt. %, and in particular 45 to 55 wt. %, surfactant.
3 The method according to one of the preceding points, wherein the dimensionally stable solid gel contains, based upon the total weight thereof, 15 to 35 wt. %, preferably 20 to 30 wt. %, aqueous-organic solvent.
4. The method according to one of the preceding points, wherein the second flowable, gelling agent-containing composition contains low-molecular-weight gelling agents having a molar mass of up to 2,000 g/mol, wherein the proportion by weight thereof with respect to the total weight of the composition is preferably less than 5 wt. %, preferably 0.1 to 5 wt. %, particularly preferably 0.1 to 2.5 wt. %.
5. The method according to one of the preceding points, wherein the second flowable, gelling agent-containing composition contains low-molecular-weight gelling agents selected from the group of cyclic dipeptides, cyclic dipeptide derivatives, and dibenzylidene sorbitols.
6. The method according to one of the preceding points, wherein the second flowable, gelling agent-containing composition contains dibenzylidene sorbitol as a low-molecular-weight gelling agent.
7. The method according to one of the preceding points, wherein the second gelling agent-containing composition also contains an organic solvent.
8. The method according to one of the preceding points, wherein the second flowable, gelling agent-containing composition contains gelling agent and organic solvent in a total weight proportion above 50 wt. %, preferably above 70 wt. %, and in particular above 90 wt. %.
9. The method according to one of the preceding points, wherein the first flowable composition and the second flowable composition are fed to the mixing device in separate lines.
10. The method according to one of the preceding points, wherein the first flowable composition and the second flowable composition are mixed in the mixing device in a weight ratio of 50:1 to 5:1, preferably 35:1 to 8:1.
11. The method according to one of the preceding points, wherein the flowable compositions in the mixing device are subjected to a shear rate of 50 to 5,000 s−1, preferably of 80 to 2,000 s−1, and in particular of 100 to 1,200 s−1.
12. The method according to one of the preceding points, wherein the mixing device is selected from the group of rotor-stator mixers.
13. The method according to one of the preceding points, wherein the mixing device is selected from the group of static-dynamic mixers.
14. The method according to one of the preceding points, wherein the surfactant-containing and gelling agent-containing mixture has a temperature above 23° C., preferably in the range of 23° C. to 60° C., upon exiting the mixing device.
15. The method according to one of the preceding points, wherein the mixing device and the shaping device are separate devices.
16. The method according to one of the preceding points, wherein the time period between the exit of the surfactant-containing and gelling agent-containing mixture from the mixing device and the entry of said mixture into the shaping device is 1 to 60 seconds, preferably 5 to 40 seconds.
17. The method according to one of the preceding points, wherein the surfactant-containing and gelling agent-containing mixture is introduced into the shaping device at a filling rate of 20 mL/s to 800 mL/s.
18. The method according to one of the preceding points, wherein the surfactant-containing and gelling agent-containing mixture is passed through a supply line after exiting the mixing device and before entering the shaping device.
19. The method according to one of the preceding points, wherein the surfactant-containing and gelling agent-containing mixture, after exiting the mixing device and before entering the shaping device, is guided through a supply line, and the cross-sectional area of the supply line differs from the cross-sectional area of the outlet opening in the shaping device.
20. The method according to one of the preceding points, wherein the surfactant-containing and gelling agent-containing mixture, after exiting the mixing device and before entering the shaping device, is guided through a supply line, and the cross-sectional area of the supply line is smaller than the cross-sectional area of the outlet opening in the shaping device.
21. The method according to one of the preceding points, wherein the surfactant-containing and gelling agent-containing mixture, after exiting the mixing device and before entering the shaping device, is guided through a supply line, and the cross-sectional area of the supply line is larger than the cross-sectional area of the outlet opening in the shaping device.
22. The method according to one of the preceding points, wherein the dimensionally stable solid gel strand is cooled.
23. The method according to one of the preceding points, wherein the dimensionally stable solid gel is cut to length subsequent to step vi).
24. The method according to one of the preceding points, wherein the dimensionally stable solid gel is cut to length subsequent to step vi) by means of ultrasonic cutting.
25. The method according to one of the preceding points, wherein the solid gel has a weight of 10 g to 28 g, preferably of 12 g to 23 g, and in particular of 15 g to 19 g.
26. The method according to one of the preceding points, wherein the solid gel has a flat underside, the largest diagonal of which is greater than the height of the solid gel.
27. The method according to one of the preceding points, wherein the solid gel has a flat underside, the largest diagonal of which is more than 1.5 times, preferably more than twice, the height of the solid gel.
28. The method according to one of the preceding points, wherein the solid gel has an oval underside.
29. The method according to one of the preceding points, wherein the solid gel has an ellipsoidal or round, preferably round, underside.
30. The method according to one of the preceding points, wherein the solid gel has an angular underside, preferably an angular underside with rounded corners.
31. The method according to one of the preceding points, wherein the solid gel has a triangular, square, or hexagonal underside.
32. The method according to one of the preceding points, wherein the solid gel has an upper side plane-parallel to the underside.
33. The method according to one of the preceding points, wherein the solid gel has an underside and an upper side which have the same geometric shape, and wherein the underside and the upper side have the same surface size.
34. The method according to one of the preceding points, wherein the solid gel has an underside and an upper side which have the same geometric shape, and wherein the underside and the upper side have different surface sizes.
35. The method according to one of the preceding points, wherein the solid gel has an underside and an upper side which are connected to one another by a cylindrical lateral surface.
36. The method according to one of the preceding points, wherein the solid gel has an underside and an upper side, and the surface area of the upper side is 80 to 100%, preferably 90 to 100%, and in particular 98 to 100% of the underside.
37. The method according to one of the preceding points, wherein the dimensionally stable solid gel strand is covered with a prefabricated shaped body.
38. The method according to one of the preceding points, wherein the dimensionally stable solid gel strand is discharged onto a prefabricated shaped body.
39. The method according to one of points 37 or 38, wherein the shaped body is present as a casting body.
40. The method according to one of points 37 to 38, wherein the shaped body is present as an extruded body, preferably as a tablet.
41. The method according to one of points 37 to 40, wherein the shaped body has a breaking strength of 50 N to 300 N, in particular of 50 N to 150 N.
42. The method according to one of points 37 to 41, wherein the shaped body has an imprint.
43. The method according to one of points 37 to 42, wherein the shaped body contains, based upon its total weight, more than 40 wt. %, preferably more than 60 wt. %, particularly preferably more than 80 wt. %, active washing or active cleaning ingredient.
44. The method according to one of points 37 to 43, wherein the shaped body contains an active washing or active cleaning ingredient from the group of fragrances.
45. The method according to one of points 37 to 44, wherein the shaped body contains an active washing or active cleaning ingredient from the group of builders, in particular at least one active substance from the group of citrates, zeolites, silicates, and carbonates, preferably from the group of citrates and zeolites.
46. The method according to one of points 37 to 45, wherein the shaped body contains a polymeric active washing or active cleaning ingredient, preferably a polymeric active washing or active cleaning ingredient from the group of celluloses and cellulose derivatives, of the anionic or non-ionic aromatic polyesters, preferably from the group of celluloses, microcrystalline celluloses, and carboxymethyl celluloses, of the anionic or non-ionic aromatic polyesters.

1. A method for manufacturing a detergent portion unit comprising a dimensionally stable solid gel, the method comprising:
mixing a first flowable, surfactant-containing composition and a second flowable, gelling agent-containing composition that is different from the first flowable, surfactant-containing composition using a mixing device to form a surfactant-containing and gelling agent-containing mixture;
passing the surfactant-containing and gelling agent-containing mixture through a shaping device until the surfactant-containing and gelling agent-containing mixture solidifies to form a dimensionally stable solid gel strand; and;
discharging the dimensionally stable solid gel strand from the shaping device.

2. The method of claim 1, wherein the first flowable, surfactant-containing composition comprises a surfactant in an amount of from 30 to 70 wt. % based on the total weight of the first flowable, surfactant-containing composition.

3. The method of claim 1, wherein the dimensionally stable solid gel comprises an aqueous-organic solvent in an amount of from 15 to 35 wt. % based on the total weight of the dimensionally stable solid gel.

4. The method of claim 1, wherein the second flowable, gelling agent-containing composition comprises a low-molecular-weight gelling agent having a molar mass of up to 2,000 g/mol, wherein the low-molecular-weight gelling agent is in an amount of from 0.1 to 5 wt. % based on the total weight of the second flowable, gelling agent-containing composition.

5. The method of claim 1, wherein the first flowable, surfactant-containing composition and the second flowable, gelling agent-containing composition have a weight ratio of from 50:1 to 5:1 in the mixing device.

6. The method of claim 1, wherein the mixing device is different from the shaping device.

7. The method of claim 1, wherein a time period between exit of the surfactant-containing and gelling agent-containing mixture from the mixing device and entry of the surfactant-containing and gelling agent-containing mixture into the shaping device is of from 1 to 60 seconds.

8. The method of claim 1, wherein the dimensionally stable solid gel strand is cut to a predetermined length after being discharged from the shaping device.

9. The method of claim 8, wherein the cut dimensionally stable solid gel strand has a weight of from 10 g to 28 g.

10. The method of claim 1, wherein the dimensionally stable solid gel strand is discharged onto or covered with a prefabricated shaped body.

11. The method of claim 2, wherein the first flowable, surfactant-containing composition comprises a surfactant in an amount of from 40 to 60 wt. % based on the total weight of the first flowable, surfactant-containing composition.

12. The method of claim 11, wherein the first flowable, surfactant-containing composition comprises a surfactant in an amount of from 45 to 55 wt. % based on the total weight of the first flowable, surfactant-containing composition.

13. The method of claim 3, wherein the dimensionally stable solid gel comprises the aqueous-organic solvent in an amount of from 20 to 30 wt. % based on the total weight of the dimensionally stable solid gel.

14. The method of claim 4, wherein the low-molecular-weight gelling agent is in an amount of from 0.1 to 2.5 wt. % based on the total weight of the second flowable, gelling agent-containing composition.

15. The method of claim 5, wherein the first flowable, surfactant-containing composition and the second flowable, gelling agent-containing composition have a weight ratio of from 35:1 to 8:1 in the mixing device.

16. The method of claim 7, wherein the time period between the exit of the surfactant-containing and gelling agent-containing mixture from the mixing device and the entry of the surfactant-containing and gelling agent-containing mixture into the shaping device is of from 5 to 40 seconds.

17. The method of claim 9, wherein the cut dimensionally stable solid gel strand has a weight of from 12 g to 23 g.

18. The method of claim 17, wherein the cut dimensionally stable solid gel strand has a weight of from 15 g to 19 g.

19. The method of claim 1, wherein the shaping device is an extruder or a rotating shaping roller.

20. The method of claim 1, wherein the detergent portion unit further comprises a polymeric active washing or active cleaning ingredient.
